(19) United States
(12) Patent Application Publication
(10) Pub. No.: US 2022/0398601 A1
(43) Pub. Date: Dec. 15, 2022

(54) System and Method for Verifying Authenticity of Physical Goods

(71) Applicant: Blokios LLC, Wauwatosa, WI (US)

(72) Inventors: Kristin Anastas, Wauwatosa, WI (US); David Snow, Tomahawk, WI (US)

(21) Appl. No.: 17/345,954

(22) Filed: Jun. 11, 2021

(51) Int. Cl. G06Q 30/00; G06K 7/10; G06K 19/07; G06K 19/073; H04L 9/08; H04L 9/30

(52) U.S. Cl. CPC G06Q 30/0185; G06K 7/10386; G06K 7/10297; G06K 19/0723; G06K 19/07372; H04L 9/088; H04L 9/30; G06Q 2220/00; G06K 2007/10504

(57) ABSTRACT

A system for verifying the authenticity of physical goods uses an NFC tag embedded in the product. An NFC reader positioned within range of the tag reads a unique identification number from the tag. The unique identification number may be used to generate an authentication code. During production, the manufacturer generates a blockchain record as a function of the authentication code. The blockchain record includes at least one additional identifier corresponding to the manufacturer. A consumer uses a mobile device to read the NFC tag and obtains the authentication code as a function of the unique identification number. Having the authentication code, the mobile device accesses the record in the blockchain and obtains the identifier corresponding to the manufacturer. Based upon scanning the NFC tag, the consumer is thereby able to obtain an identifier of the manufacturer to ensure authenticity of the product being purchased.

### BACKGROUND OF THE INVENTION

### Field of the invention

The subject matter disclosed herein relates to a system and method of authenticating physical goods via records stored in a public blockchain. More specifically, a physical tag, containing a unique identifier, is embedded within a physical good during manufacture, and a blockchain record including the unique identifier and manufacturer are created. A consumer may scan the physical tag to access the blockchain record and verify authenticity of the physical good.

### Description of the Related Art

Brand owners and manufacturers invest heavily in brand identity and consumer trust. Manufacturers invest in quality materials and manufacturing methods to deliver safe products which will perform up to certain expectations. Millions, if not billions, of dollars are spend on advertising products to create brand awareness. Consumers expect certain levels of quality based on the brand identity and reputation of a manufacturer.

Counterfeit goods erode public trust in brand identity and reputation of the manufacturer. Counterfeit goods are commonly produced using inferior materials and manufacturing techniques and often do not perform as well as the original product they are imitating. Counterfeit goods are manufactured as inexpensively as possible while still maintaining a sufficient resemblance to the original product to trick a consumer into purchasing the counterfeit product. Counterfeit goods cause both a loss of trust as well as a loss of revenue for the original brand owner.

There have been many attempts made by brand owners to distinguish their original product from counterfeit goods. A manufacturer may attach a sticker with a holographic image or a printed Quick Response (QR) code to the good. The manufacturer may utilize a specific logo or a particular method of manufacture, such as stitching used on textiles or leather goods. Such techniques may be reproduced, at varying levels of success, by the counterfeiter. While a consumer may be able to detect some differences between an original product and a counterfeit product, some products must be sent to a third-party expert to verify authenticity. Certain counterfeit goods may even deceive the third-party expert.

Thus, it would be desirable to provide an improved system for verifying the authenticity of physical goods.

BRIEF DESCRIPTION OF THE INVENTION

The subject matter disclosed herein describes an improved system for verifying the authenticity of physical goods. A manufacturer mounts a tag to a product in a manner where tampering with the tag after manufacture is evident. The tag is a passive device configured to operate with near field communication (NFC) technology. When an NFC reader is positioned within range of the tag, power is harvested by the NFC tag from the NFC reader via inductive coupling to wake up the NFC tag. The NFC reader may then communicate with the NFC tag while the NFC tag is within range of the reader. Each NFC tag includes a unique identification number stored on the tag which may be read by the NFC reader. During production, the manufacturer uses the unique identifier to create an authentication code. The authentication code and at least one additional identifier corresponding to the manufacturer are then stored as a record in a blockchain. The record in the blockchain establishes a relationship between the unique identifier stored on the NFC tag and the manufacturer that is immutable for the lifetime of the product.

A consumer of the good may subsequently use this record in the blockchain to verify the authenticity of a good during a purchase. Many mobile devices, such as cellular phones, tablets, and the like, include NFC technology. Placing the mobile device next to the product and within range of the tag mounted to the product allows the mobile device to read the unique identifier on the tag. The mobile device may then access a website to obtain the same authentication code generated by the manufacturer as a function of the unique identifier. The website on which the authentication code is generated may be further configured to access the blockchain and obtain the identifier corresponding to the manufacturer. Based upon scanning the NFC tag, the consumer is thereby able to obtain an identifier corresponding to the manufacturer of the product to ensure authenticity of the product being purchased.

According to one embodiment of the invention, a method for verifying authenticity of a product includes scanning a tag mounted to the product with a mobile device, receiving at the mobile device a unique identifier corresponding to the tag, and transmitting the unique identifier to an authentication sever. A record from a blockchain is received with the mobile device as a function of an authentication code generated by the authentication server, and the record is displayed on the mobile device. The authentication code is generated as a function of the unique identifier, and the record verifies authenticity of the product.

According to other aspects of the invention, the tag is mounted to the product in a manner where tampering with the tag after mounting is evident. The record includes at least one additional identifier of either a manufacturer of the product or of the product and the at least one additional identifier is displayed on the mobile device.

According to still other aspects of the invention, the unique identifier may be encrypted as a function of a public key stored on the tag, and the authentication server may include a private key to decrypt the unique identifier before the authentication code is generated. The authentication code may be a cipher-based message authentication code.

According to another embodiment of the invention, a method for verifying authenticity of a product includes scanning a tag mounted to the product with a tag reader, receiving at the tag reader a unique identifier corresponding to the tag, and transmitting the unique identifier from the tag reader to an authentication sever with a computing device. An authentication code is generated with the authentication server as a function of the unique identifier. The authentication code and at least one identifier for authentication are transmitted to a blockchain manager to generate an initial record in a blockchain, where the initial record includes the authentication code and the at least one additional identifier.

According to still another embodiment of the invention, a system for verifying authenticity of a product includes a tag, a tag reader, and an authentication server. The tag is configured to be mounted to the product in a manner where tampering with the tag after mounting is evident, and the tag includes a unique identifier. The tag reader is configured to read the unique identifier from the tag, and an authentication server in communication with the tag reader is configured to receive the unique identifier from the tag reader and to generate an authentication code as a function of the unique identifier. A blockchain includes multiple ledgers, where each of the ledgers receives the authentication code and at least one additional identifier corresponding to the product. The authentication code is used as a signature of a block stored in each of the ledgers, where the at least one additional identifier is stored in the block. A mobile device is configured to read the unique identifier from the tag. The mobile device is in communication with the authentication server to transmit the unique identifier to the authentication server, and the mobile device is configured to receive the additional identifier from the blockchain responsive to reading the unique identifier from the tag and transmitting the unique identifier to the authentication server.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Various exemplary embodiments of the subject matter disclosed herein are illustrated in the accompanying drawings in which like reference numerals represent like parts throughout, and in which:

FIG. 1 is an exemplary environmental view of a consumer authenticating a physical good according to one embodiment of the invention;

FIG. 2 is an exemplary screen shot of the mobile device of FIG. 1 reporting that the physical good is authentic;

FIG. 3 is a block diagram representation of the mobile device and product of FIG. 1 in communication with a blockchain;

FIG. 4 is an exemplary environmental view of a work station at a manufacturer of the physical good in FIG. 1;

FIG. 5 is a block diagram representation of the work station of FIG. 4 in communication with the blockchain;

FIG. 6 is a block diagram representation of the work station of FIG. 4 generating a record in the blockchain;

FIG. 7 is a block diagram representation of the mobile device of FIG. 1 accessing the record of FIG. 6; and

FIG. 8 is an exemplary block of data stored in the blockchain.

In describing the various embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF THE INVENTION

The various features and advantageous details of the subject matter disclosed herein are explained more fully with reference to the non-limiting embodiments described in detail in the following description.

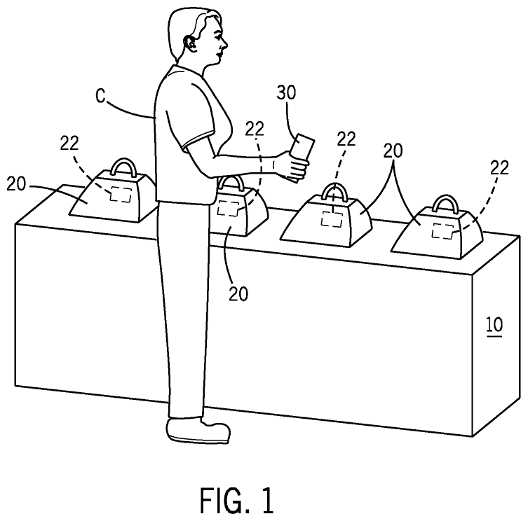

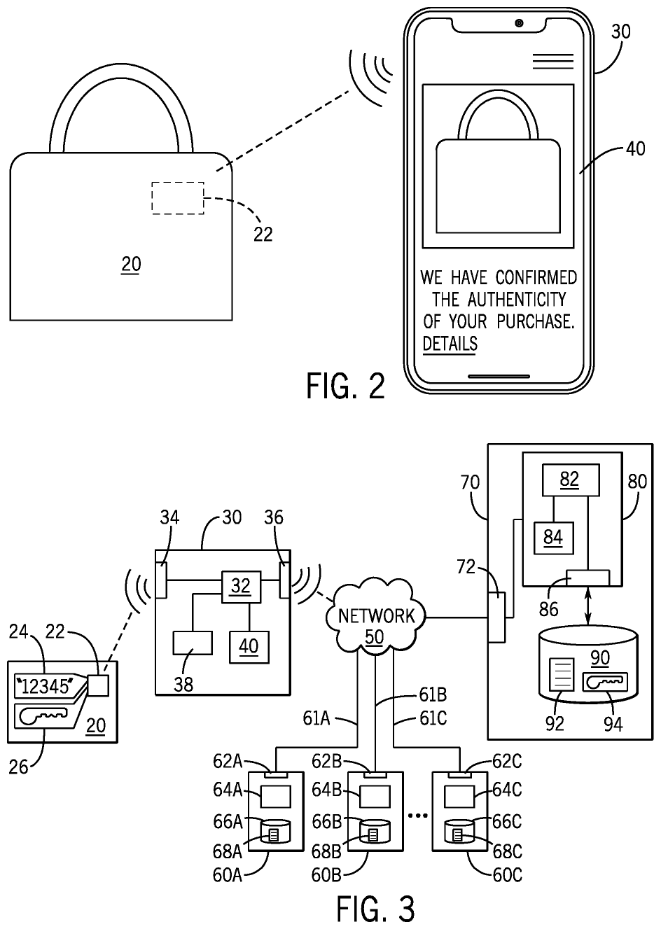

Turning initially to FIGS. 1 and 2, a consumer, C, is illustrated next to a table 10 holding product 20 to be purchased. According to the illustrated embodiment, the product 20 under consideration is a purse. Purses are manufactured at many price points and of varying quality. When the consumer, C, is considering a purse from what is considered a luxury product line, the consumer wishes to have a degree of confidence that the product 20 is authentic. According to one embodiment of the present invention, the consumer, C, may use a mobile device 30, such as a cellular phone, to scan a tag 22 embedded in the product 20 to verify that the product is an authentic product from the luxury manufacturer. As will be described in more detail below, the mobile device 30 scans the tag 22 to obtain a unique identifier associated with the purse. The mobile device 30 may then use the unique identifier to access a record in a blockchain and verify the authenticity of the goods. By following a few prompts on the mobile device 30 after scanning the tag, the consumer, C, may receive confirmation on the display 40 of the mobile device 30 that the product 20 is authentic. The mobile device 30 may be any suitable electronic device configured to act as an NFC reader. It is contemplated that the mobile device 30 may include general purpose devices such as a mobile phone or a tablet, configured to be carried by a consumer and capable of multiple functions. Optionally, the mobile device 30 may be a dedicated device for reading NFC tags and providing verification of the authenticity of a product having a smaller form factor and including, for example, a ring to mount to a keychain, purse, or other bag or to fit in a pocket.

Turning next to FIG. 3, a general block diagram of the product 20, mobile device 30, and exemplary environment of one embodiment of the invention is illustrated. The product 20 includes a tag 22 embedded in the product. The tag 22 is preferably a passive NFC tag configured to receive power from an NFC reader when the NFC reader is positioned within communication range of the tag 22. According to one embodiment of the invention, the NFC tag 22 will communicate with an NFC reader positioned within twenty centimeters (20 cm) of the tag and preferably within ten centimeters (10 cm) of the tag. The tag 22 harvests power from the NFC reader via inductive coupling to power its own communication interface. The tag 22 includes a unique identifier 24 stored in non-volatile memory included within the tag.

The mobile device 30 includes a processor 32 in communication with memory 38. The processor 32 may include a single processor or multiple processors. The processors may operate synchronously or asynchronously. Optionally, a single processor may include multiple processing cores, where each processor and/or core may execute one or more applications. The memory 38 may include volatile memory, non-volatile memory, or a combination thereof. The memory 38 stores an operating system and applications configured to be executed by the processor 32. The mobile device includes a display 40, which is commonly configured as a touch-screen. The display 40 provides an interface to the consumer, C, to both receive input from and to provide information to the consumer. Each mobile device 30 also includes an NFC communication interface 34 embedded within the device. The NFC communication interface 34 may communicate with the interface present on the tag 22 when the mobile device 30 is within range of the tag 22. The mobile device 30 also includes a second communication interface 36 configured to communicate with a network 50. According to one embodiment of the invention, the second communication interface 36 is configured to communicate on a cellular network. Optionally, it is contemplated that the second communication interface 36 may be a wi-fi interface configured to wirelessly communicate to a wi-fi router. In either embodiment, the Internet is considered to be at least a portion of the network 50 and the mobile device 30 accesses the Internet via the cellular and/or wi-fi interface.

A number of servers 60, 70 are connected to the network 50 via the Internet. A first set of servers 60 serve as ledger nodes for a blockchain. Each ledger node 60 includes a communication interface 62 and network media 61 connecting the ledger node 60 to the network 50. The network media 61 may include wired connections, wireless connections, or a combination thereof. Each ledger node 60 includes a processor 64 and a storage medium 66 in communication with the processor 64. A ledger 68 is stored in the storage medium 66 of the respective ledger node 60, and each ledger maintains a record of transactions in the blockchain.

A blockchain is a distributed database. Each ledger 68 maintains a record of the data in the distributed database. Data entered into the database is immutable, or in other words, will not change once entered. A blockchain manager executes on each ledger node 60 to manage the data within its respective ledger 68. Data is entered into the database as a block of data. Once written, the data will not change. If the data or a status of the data needs to change, then a new block is created with a “chain”, also referred to as a pointer or a reference, to the earlier block containing the original data. Thus, a permanent record is established containing the original data and any changes to the data or any changes to the status of the data. A blockchain manager executing on the ledger node 60 may create a new, original block of data also referred to as an initial record. The blockchain manager may also create status blocks, chained to the initial record with changes to the data or to the status of the data. The blockchain manager on one node periodically updates each of the peers on other ledger nodes 60 with changes so that every ledger 68 maintains a record of the data. The chained blocks include a field which is generated as a function of prior blocks in the chain. Thus, blockchain managers may execute validation equations to ensure the validity of changes to the records. After validating changes and voting on accepting the changes, blockchain managers store changes made at other nodes 60 in the ledger 68 at their corresponding node 60. In this manner, data is securely stored within the distributed database.

An additional server 70 is labelled as an authentication server. The authentication server 70 includes a processing system 80 and at least one storage device 90 in communication with the processing system 80. The illustrated processing system 80 includes a processor 82 and memory 84 in communication with the processor 82. The processing system 80 may include a single processor or multiple processors. The processors 82 may operate synchronously or asynchronously. Optionally, a single processor may include multiple processing cores, where each processor and/or core may execute one or more applications. The memory 84 may include volatile memory, non-volatile memory, or a combination thereof. The processing system 80 also includes an interface 86 in communication with the storage device 90. The illustrated storage device may also include a copy of the ledger 92. Although illustrated with different reference numerals, this is for ease of reference. It is contemplated that the authentication server 70 may be a ledger node 60 and the ledger 92 on the authentication server 70 may be a copy of the ledgers 68 on each ledger node 60.

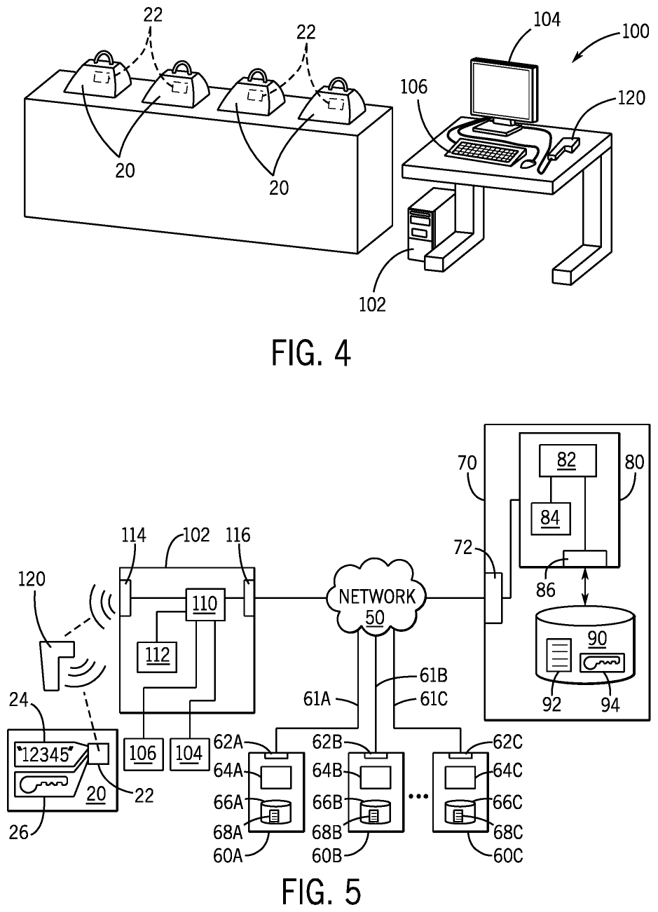

Turning next to FIG. 4, an exemplary workstation 100 for a manufacturing site is illustrated. The workstation 100 includes a computing device 102. The illustrated computing device 102 may be a desktop or tower-style computer chassis connected to a monitor 104 and a user interface 106. The illustrated user interface 106 is a keyboard, but may include, but is not limited to a mouse, a trackball, a touchpad, a touchscreen, a pointer, a stylus, a microphone and headset or any other suitable user interface to receive input from a user. Although illustrated as separate components, it is further contemplated that the computing device 102 may be a single device, such as a laptop, notebook, or tablet computer. Further, the computing device 102 may be an industrial computer suitable for a manufacturing environment. The illustration is intended to be exemplary only and is not limiting. The workstation 100 also includes a tag reader 120 in communication with the computing device 102. The tag reader is configured to communicate with tags 22 mounted in the product 20. Although the product 20 is illustrated as a purse, this illustration is exemplary only and is not intended to be limiting. It is contemplated that the tag 22 may be mounted to many types of products where authentication is desired. Such products may be luxury goods including but not limited to shoes, garments, watches, or electronics.

With reference also to FIG. 5, each tag 22 includes a unique identifier 24 and is configured to store a limited amount of data. The tag reader 120 is configured for bidirectional communication between the computing device 102 and the NFC tag 22. The tag reader 120 is configured to communicate via near field communication with the NFC tag 22, and the tag reader 120 is further configured to communicate with a first communication interface 114 on the computing device. The first communication interface 114 may be a wired or wireless communication interface according to the requirements of the tag reader 120. The tag reader 120 is configured to read a unique identifier 24 from the NFC tag 22 and to write a Uniform Resource Locator (URL) to the NFC tag 22. The URL is used by the consumer, as described in more detail below, to confirm authenticity of the goods.

The computing device 102 includes a processor 110 and memory 112 in communication with the processor 110. The processor 110 may include a single processor or multiple processors. The processors may operate synchronously or asynchronously. Optionally, a single processor may include multiple processing cores, where each processor and/or core may execute one or more applications. The memory 112 may include volatile memory, non-volatile memory, or a combination thereof. The memory 112 stores an operating system and applications configured to be executed by the processor 110. The computing device includes a second communication interface 116. In some embodiments, the first and second communication interfaces may be a common interface. The second communication interface 116 is configured to communicate via the network 50 to the authentication server 70 and to ledger nodes 60.

In operation, the tag 22 mounted to a product 20 allows a consumer, C, to verify the authenticity of the product. The tag 22 is mounted to the product 20 in a manner where tampering with the tag after mounting is evident. The tag 22 may be provided in a number of different forms. The tag 22 may be, for example, a circuit printed on a flexible substrate. The flexible substrate may be sewn between layers of a garment, within a lining of a purse, between layers of a shoe, or mounted in a similar manner on other products. Removal or exchange of the tag 22 would require at least partial disassembly and reassembly of the product 20. Such tampering with the tag 22 would result in noticeable damage to or differences in the reassembly of the product 20. Optionally, certain goods may be suited for mounting a rigid tag. In these applications, the circuit may be printed on a rigid substrate and adhered via adhesive, soldering, ultrasonic welding, or other attachment method such that removal or exchange of the tag 22 would provide evidence of such removal on the surface of the product 20 to which the tag is mounted.

In addition to providing physical evidence of tampering, each tag 22 may be configured to be resistant to digital tampering as well. According to one embodiment of the invention, a public key 26 may be loaded onto each tag 22 at manufacture. The tag 22 is configured to communicate using secure communications and uses the public key to encrypt data transmitted from the tag 22 to a device 30 reading data from the tag. Thus, when a mobile device 30 scans the tag 22, the unique identifier 24 for the tag 22 may be encrypted using the public key prior to transmission the mobile device.

In addition to transmitting the unique identifier 24, each tag 22 is also configured to transmit the URL, or web address, to the mobile device 30 along with the encrypted identifier. The URL identifies the web address by which the mobile device 30 communicates with authentication server 70. According to one embodiment of the invention, a function included with the operating system on the mobile device 30 is configured to read the URL from the NFC communication interface 34 and direct the mobile device 30 to access the URL. The function may be configured to first provide a prompt on the display 40 of the mobile device 30 indicating to the consumer, C, that it is attempting to access the URL and request permission from the consumer to continue to the authentication server 70. According to another embodiment of the invention, the manufacturer may provide an application, executable on the mobile device 30, where the consumer, C, launches the application prior to scanning the product 20. The application executing on the mobile device 30 may be configured to read the URL and direct the consumer, C, to the authentication server 70. Thus, in either embodiment of the invention, the mobile device 30 receives the URL of the authentication server 70 along with the encrypted unique identifier 24 and establishes a connection to the authentication server 70 via the network 50.

The authentication server 70 is configured to interface with data from an NFC tag 22. According to one embodiment of the invention, the authentication server 70 is configured to host a website for the manufacturer. According to another embodiment of the invention, the authentication server 70 is configured to host a website for a third party, providing authentication of the product as a service. The authentication server 70 includes libraries stored on the storage device 90 and executable by the processor 82 for interfacing with the NFC tag 22. The website is configured to access the library stored on the storage device 90 when a mobile device 30 attempts to access the website as a result of scanning the NFC tag 22. The website responds to the request for communication from the mobile device 30 and establishes a secure communication channel with the mobile device 30.

After establishing a secure communication channel between the authentication server 70 and the mobile device 30, the unique identifier 24 is transmitted from the mobile device 30 to the authentication server 70. According to one embodiment of the invention, the encrypted unique identifier 24 may be transmitted along with the initial request by the mobile device 30 to establish a secure communication channel. Optionally, the unique identifier 24 may be transmitted from the mobile device 30 to the authentication server 70 upon establishing the secure communication channel. According to still another option, the authentication server 70 may request the unique identifier 24 upon establishing the secure communication channel. Having received the unique identifier 24, the authentication server 70 generates an authentication code as a function of the unique identifier.

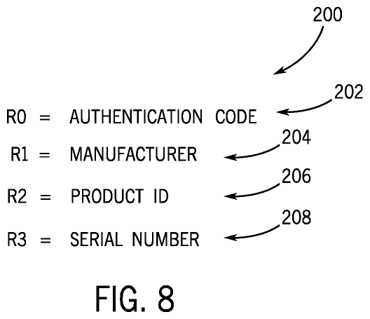

The manufacturer establishes the authentication server 70 to generate the authentication code. The authentication server 70 may be any server accessible via the network 50. It may be a private server established by the manufacturer or a server connected to the Internet via the cloud and contracted for use by the manufacturer where the server is provided as Infrastructure as a Service (IaaS). The private key 94, corresponding to the public key stored on the tag, is provided to the authentication server 70 where it is securely stored on the storage device 90. The public/private key pair may be generated by the manufacturer of the tag 22, by a third party offering authentication as a service, or by the manufacturer of the product 20. The public key is preferably stored on the tag 22 when the tag is manufactured, and the private key is provided to the authentication server 70 as the authentication server 70 is configured to generate authentication codes and access the blockchain. When the unique identifier 24 is encrypted, the authentication server is able to first decrypt the identifier 24 into clear data using the private key 94. Alternately, when the unique identifier 24 is not encrypted, the identifier 24 is already present as clear data. The authentication server 70 is configured to use the unique identifier 24, in clear form, to generate an authentication code 202 (see also FIG. 8). The authentication server 70 is configured to use the clear text identifier 24 in a hash algorithm to generate the authentication code. According to one embodiment of the invention, the authentication server 70 utilizes a Cipher-based Message Authentication Code (CMAC) as the authentication code. The authentication server 70 uses a private key for generation of the CMAC. The private key for generation of the CMAC may be the same private key 94 utilized for encryption or may be a second private key. The unique identifier 24 and private key for generation of the CMAC are combined via the CMAC function to generate the authentication code 202. The authentication code 202, in turn, is used to establish a blockchain record 200 corresponding to the unique identifier 24.

With reference to FIG. 6, the steps performed by the manufacturer to register each tag 22 in a blockchain are illustrated. The NFC reader 120 at the workstation 100 is used to scan a tag 22 mounted to a product 20. The NFC reader 120 requests the unique identifier 24 from the tag 22, and the tag 22 transmits the unique identifier 24 back to the NFC reader 120. Along with the unique identifier 24, the NFC tag 22 transmits the URL of the authentication server 70. The computing device 102 at the workstation 100 uses the URL to establish communication with the authentication server 70 and transmits the unique identifier 24 to the authentication server 70. After generating the authentication code 202, the authentication server 70 returns the authentication code (illustrated as Return RO) to the computing device 102. The computing device 102 then establishes communication with a blockchain manager and requests that the blockchain manager create an initial record 200 in the blockchain associating the tag 22 with the authentication code. Upon adding the initial record 200 to the blockchain, the blockchain manager returns an acknowledgement to the computing device.

An exemplary initial record 200 is illustrated in FIG. 8. It is contemplated that the records present in the initial record 200 may vary according to the requirements of the manufacturer. An initial record, RO, will include the authentication code 202. The remaining records may vary. According to the illustrated embodiment, the additional records may include a manufacturer record 204, identifying the manufacturer of the product 20; a Product ID record, identifying a manufacturer's name, model, or the like defining the product 20 in which the tag 22 is mounted; and a serial number record, including a serial number for the product 20. Other records may include, but are not limited, to a version number, date of manufacture, color, style, product options, or any other identifying information corresponding to the product 20.

The blockchain manager uses the authentication code as an initial record, providing the unique fingerprint for the initial record 200, and for future identification of the record. The blockchain manager may be executing any one of the ledger nodes 60. The initial record 200 becomes an initial block corresponding to the tag 22 which was read by the NFC reader 120. This block is an immutable block written to the ledger 68 in the corresponding node 60. At periodic intervals a ledger node 60 will update each of the other ledger nodes of any changes in its ledger 68. The initial record 200, therefore, becomes written to each of the ledgers 68 in the distributed database. Any additional information that the manufacturer wishes to store regarding the product 20 corresponding to the tag 22 is appended, or chained, to the original block in the form of a new block. The original, initial record 200 remains in the distributed database of each ledger 68 for subsequent validation of the authenticity of the product 20 by a consumer.

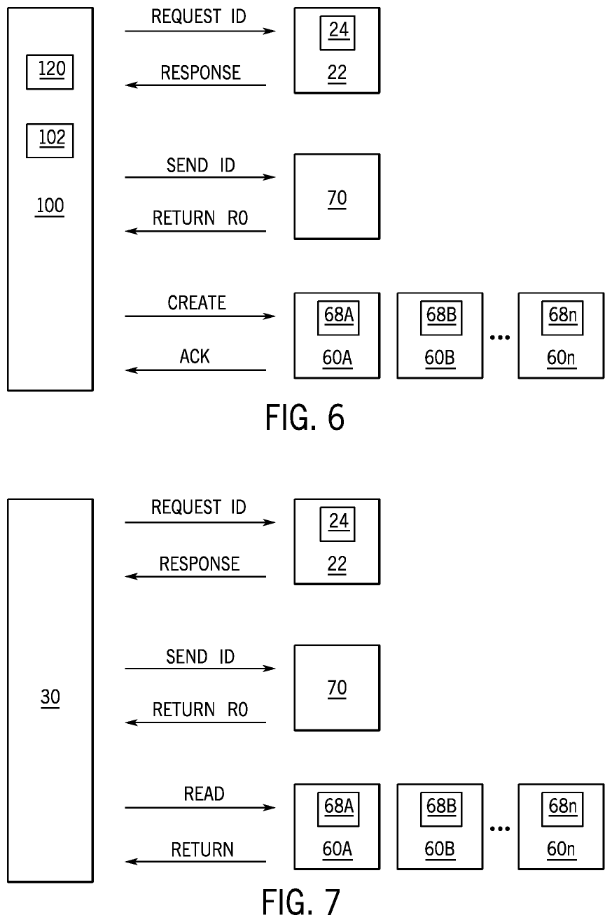

Turning next to FIG. 7, the steps performed by the consumer to verify authenticity of a product 20 are illustrated. The consumer, C, places their mobile device 30 adjacent the product 20 such that it is within range of the tag 22 mounted to the product 20. The mobile device 30 requests the unique identifier 24 from the tag 22, and the tag 22 transmits the unique identifier 24 and the URL of the authentication server 70 back to the mobile device 30. The mobile device 30 may provide a prompt to the consumer, C, requesting authorization to access the URL received from the tag 22. Upon granting the authorization, the mobile device 30 establishes communication with the authentication server 70 and sends the unique identifier 24 to the authentication server 70. When the manufacturer wishes to have the unique identifier 24 encrypted, the public key 26 will have been stored on the tag 22 and the private key 94 stored on the authentication server 70. The unique identifier 24 will be encrypted during its transmission from the tag 22 to the mobile device 30 and on to the authentication server 70. The authentication server 70 then decrypts the unique identifier 24 to clear data using the private key 94. If the manufacturer does not choose to encrypt the unique identifier 24, no key is stored in either the tag 22 or the authentication server 70 and the unique identifier is transmitted as clear data. The authentication server 70 may determine whether the unique identifier 24 requires decryption based on the presence of a private key 94 stored on the authentication server 70. The authentication server 70 generates the authentication code in the same manner as it initially generated the authentication code during the manufacturing process. Thus, the authentication code 202 generated for the consumer, C, is identical to the authentication code 202 generated for the manufacturer for the same unique identifier 24. The authentication server 70 returns the authentication code 202 to the mobile device 30.

Having obtained the authentication code 202, the consumer is able to examiner the blockchain to determine whether an initial record 200 corresponding to the tag 22 the consumer just scanned was created by the manufacturer. According to one embodiment of the invention, it is contemplated that the authentication server 70 may be further configured to access the blockchain ledgers 68. As previously discussed, the URL stored on the tag 22 may be configured by the manufacturer. The manufacturer may provide an application to a consumer for execution on the mobile device 30 which guides the consumer through the steps in verifying authenticity of the product 20. The application may include the library for communicating with the blockchain manager. Alternately, the application may include another URL for communicating with a node 60 on which the blockchain manager is executing. As still another option and rather than providing an application for the consumer to execute on the mobile device, the manufacturer may provide a URL which is a link to a page on the manufacturer's website. The page may provide instruction to the consumer to access the authentication server 70 and/or to access a node 60 on which the blockchain manager is executing. According to still another option, the authentication server 70 may be configured to directly communicate with the blockchain manager. The authentication server 70 may pass the authentication code 202 to the blockchain manager. Because this authentication code 202 is used as the unique signature to identify a block on the blockchain, the blockchain manager may read the record associated with the authentication code 202. The blockchain manager may read the other records or provide links to the other records for the mobile device 30 to retrieve the information. The mobile device 30 then receives the data from the other records R1-R3, associated with the authentication code 202, R0. The additional data may be presented on the display 40 of the mobile device. Based on the display of the data, the consumer has confidence that the manufacturer created the record and, in turn, the consumer has confidence that the product is authentic.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A method for verifying authenticity of a product, comprising the steps of:
scanning a tag mounted to the product with a mobile device;
receiving at the mobile device a unique identifier corresponding to the tag;
transmitting the unique identifier to an authentication sever;
receiving a record with the mobile device from a blockchain as a function of an authentication code, wherein the authentication code is generated the authentication server as a function of the unique identifier; and
displaying the record on the mobile device, wherein the record verifies authenticity of the product.

2. The method of claim 1 wherein the tag is mounted to the product in a manner where tampering with the tag after mounting is evident.

3. The method of claim 1 wherein the record includes at least one additional identifier of either a manufacturer of the product or of the product and wherein the at least one additional identifier is displayed on the mobile device.

4. The method of claim 1 wherein the unique identifier is encrypted as a function of a public key stored on the tag.

5. The method of claim 4 wherein the authentication server includes a private key and the unique identifier is decrypted with the private key before the authentication code is generated.

6. The method of claim 1 wherein the authentication code is a cipher-based message authentication code.

7. The method of claim 1 further comprising the initial steps of:
scanning the tag mounted to the product at a manufacturer of the product with a tag reader;
receiving at the tag reader the unique identifier corresponding to the tag;
transmitting the unique identifier from the tag reader to the authentication sever with a computing device;
generating the authentication code with the authentication server as a function of the unique identifier; and
transmitting the authentication code and at least one identifier for authentication to a blockchain manager to generate an initial record in the blockchain, wherein the initial record includes the authentication code and the at least one identifier.

8. A method for verifying authenticity of a product, comprising the steps of:
scanning a tag mounted to the product with a tag reader;
receiving at the tag reader a unique identifier corresponding to the tag;
transmitting the unique identifier from the tag reader to an authentication sever with a computing device;
generating an authentication code with the authentication server as a function of the unique identifier; and
transmitting the authentication code and at least one additional identifier for authentication to a blockchain manager to generate an initial record in a blockchain, wherein the initial record includes the authentication code and the at least one additional identifier.

9. The method of claim 8, further comprising the steps of:
receiving the authentication code at the computing device from the authentication server; and
generating a plurality of records with the computing device, wherein the plurality of records includes the authentication code and the at least one additional identifier, and wherein the step of transmitting the authentication code and the at least one additional identifier transmits the plurality of records from the computing device to the blockchain manager.

10. The method of claim 8, wherein the computing device transmits the at least one additional identifier to the authentication server and the authentication server transmits the authentication code and the at least one additional identifier to the blockchain manager.

11. The method of claim 8, wherein the tag is mounted to the product in a manner where tampering with the tag after mounting is evident.

12. The method of claim 8, wherein the authentication code is a cipher-based message authentication code.

13. The method of claim 12, further comprising a step of storing a key on the authentication server, wherein the authentication code is generated as a function of the unique identifier and the key.

14. The method of claim 8 further comprising the steps of:
storing a public key on the tag, wherein the public key is used to encrypt the unique identifier; and
storing a private key on the authentication server, wherein the private key is used to decrypt the unique identifier.

15. The method of claim 8 further comprising the steps of
scanning the tag mounted to the product with a mobile device;
receiving at the mobile device the unique identifier corresponding to the tag;
transmitting the unique identifier to the authentication sever;
generating the authentication code as a function of the unique identifier scanned by the mobile device;
obtaining the at least one identifier from the initial record in the blockchain as a function of the authentication code; and
displaying the at least one identifier on the mobile device to verify authenticity of the product.

16. A system for verifying authenticity of a product, the system comprising:
a tag configured to be mounted to the product in a manner where tampering with the tag after mounting is evident, wherein the tag includes a unique identifier;
a tag reader configured to read the unique identifier from the tag;
an authentication server in communication with the tag reader and configured to:
receive the unique identifier from the tag reader, and
generate an authentication code as a function of the unique identifier; a blockchain having a plurality of ledgers, wherein:
each of the plurality of ledgers receives the authentication code and at least one additional identifier corresponding to the product, and
the authentication code is used as a signature of a block stored in the plurality of ledgers, wherein the at least one additional identifier is stored in the block; and a mobile device configured to read the unique identifier from the tag, wherein:
the mobile device is in communication with the authentication server to transmit the unique identifier to the authentication server, and
the mobile device is configured to receive the additional identifier from the blockchain responsive to reading the unique identifier from the tag and transmitting the unique identifier to the authentication server.

17. The system of claim 16 wherein the authentication server is further configured to:
identify the block in the blockchain in which the additional identifier is stored as a function of the authentication code,
obtain the additional identifier from the blockchain, and
transmit the additional identifier to the mobile device responsive to receiving the unique identifier for the tag from the mobile device.

18. The system of claim 16, further comprising a computing device in communication with the tag reader and the authentication server, wherein the computing device is configured to:
receive the unique identifier from the tag reader, and
transmit the unique identifier to the authentication server via a network.

19. The system of claim 18, wherein:
the mobile device receives an encrypted unique identifier from the tag, wherein the unique identifier is encrypted as a function of a public key,
the mobile device transmits the encrypted unique identifier to the authentication server, and
the authentication server is configured to decrypt the encrypted unique identifier as a function of a private key. 20 The system of claim 18, wherein the computing device is further configured to:
receive the authentication code from the authentication server responsive to the computing device transmitting the unique identifier to the authentication server,
generate a plurality of records, wherein the plurality of records includes the authentication code and the at least one identifier, and
transmit the authentication code and the at least one identifier to a blockchain manager for storing in the plurality of ledgers.
